(19) United States
(12) Patent Application Publication
(10) Pub. No.: US 2026/0205551 A1
(43) Pub. Date: Jul. 16, 2026

(54) SHEET POSTPROCESSING APPARATUS AND IMAGE FORMING SYSTEM THEREWITH

(71) Applicant: KYOCERA Document Solutions Inc., Osaka (JP)

(72) Inventor: Katsuhiko HANAMOTO, Osaka (JP)

(73) Assignee: KYOCERA Document Solutions Inc., Osaka (JP)

(21) Appl. No.: 19/439,967

(22) Filed: Jan. 5, 2026

(30) Foreign Application Priority Data
Jan. 15, 2025 (JP) 2025-005507

(51) Int. Cl. H04N 1/00

(52) U.S. Cl. CPC H04N 1/00649; H04N 1/00602; H04N 2201/0094

(57) ABSTRACT

A sheet postprocessing apparatus includes a postprocessing portion, a pair of discharge rollers, and a discharge tray. The pair of discharge rollers is composed of an upper discharge roller and a lower discharge roller that can be brought into and out of contact with each other. The sheet postprocessing apparatus further includes a holder, a pressing portion, and a control portion. The holder supports the upper discharge roller rotatably and is supported to be pivotable with respect to an apparatus body. The pressing portion presses the upper discharge roller against the lower discharge roller by compressing an elastic member connected to the holder. The control portion can change the degree of compression of the elastic member by controlling the operation of the pressing portion.

### INCORPORATION BY REFERENCE

This application is based on and claims the benefit of priority from Japanese Patent Application No. 2025-005507 filed on January 15, 2025, the contents of which are hereby incorporated by reference.

### BACKGROUND

The present disclosure relates to a sheet postprocessing apparatus and to an image forming system therewith

Known sheet postprocessing apparatuses include a postprocessing portion, a pair of discharge rollers, and a discharge tray. The postprocessing portion performs predetermined processing on sheets stacked on a processing tray. The pair of discharge rollers is disposed downstream of the processing tray in the sheet discharge direction and discharges sheets along the conveying direction while holding the sheets. On the discharge tray, the sheets discharged by the pair of discharge rollers are stacked. The pair of discharge rollers is composed of an upper discharge roller and a lower discharge roller that can be moved into and out of contact with each other.

The roller pressure from the upper discharge roller to the lower discharge roller is variable and is changed according to the number of sheets stacked on the processing tray.

Inconveniently, with the configuration above, the roller pressure is changed every time the number of postprocessed sheets is changed. Thus, discharging bundles of sheets with varying numbers of sheets sequentially from the pair of discharge rollers may take time.

An object of the present disclosure is to provide a sheet postprocessing apparatus with improved sheet postprocessing speed, and to provide an image forming apparatus provided with such a sheet postprocessing apparatus.

### SUMMARY

To achieve the above object, according to a first configuration of the present disclosure, a sheet postprocessing apparatus includes a postprocessing portion, a pair of discharge rollers, and a discharge tray. The postprocessing portion performs predetermined postprocessing on a sheet staked on a processing tray. The pair of discharge rollers is disposed downstream of the processing tray in the sheet discharge direction, and discharges the sheet along the conveying direction while holding it. On the discharge tray, the sheet discharged by the pair of discharge rollers is stacked. The pair of discharge rollers is composed of an upper discharge roller and a lower discharge roller that can be brought into and out of contact with each other. The sheet postprocessing apparatus further includes a holder, a pressing portion, and a control portion. The holder supports the upper discharge roller rotatably and is supported so as to be pivotable with respect to an apparatus body. The pressing portion presses the upper discharge roller against the lower discharge roller by compressing an elastic member connected to the holder. The control portion can change the degree of compression of the elastic member by controlling the operation of the pressing portion.

This and other objects of the present disclosure, and the specific benefits obtained according to the present disclosure, will become apparent from the description of embodiments which follows.

### BRIEF DESCRIPTION OF THE DRAWINGS

FIG. 1 is a diagram schematically showing the construction of a sheet postprocessing apparatus 1 according to an embodiment of the present disclosure.

FIG. 2 is a side sectional view on an enlarged scale around a pair of discharge rollers 81 in the sheet postprocessing apparatus 1 according to the embodiment of the present disclosure.

FIG. 3 is a side sectional view on an enlarged scale around the pair of discharge rollers 81 in the sheet postprocessing apparatus 1 according to the embodiment of the present disclosure.

FIG. 4 is a perspective view on an enlarged scale around the pair of discharge rollers 81 in the sheet postprocessing apparatus 1 according to the embodiment of the present disclosure.

### DETAILED DESCRIPTION

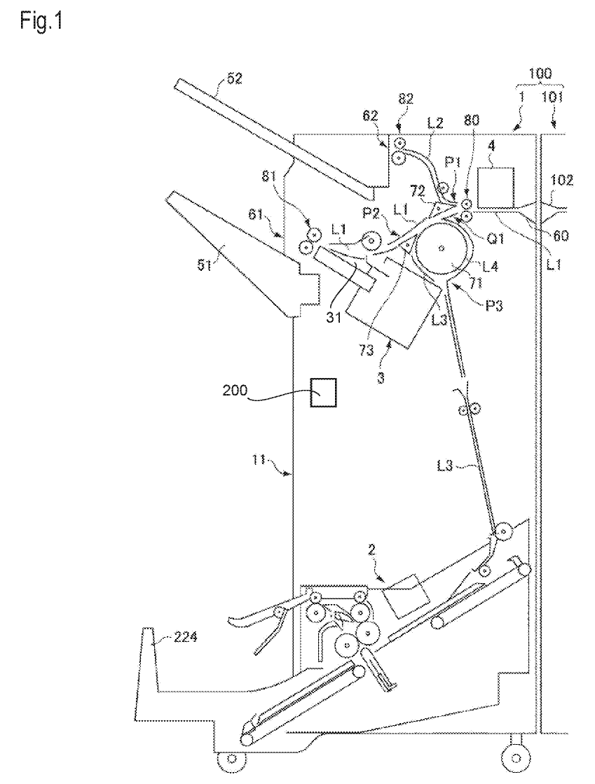

Now, with reference to the accompanying drawings, a multifunction peripheral (image forming system) as an image forming apparatus according to one embodiment of the present disclosure will be described. FIG. 1 is a schematic sectional view illustrating an outline of a multifunction peripheral body 101 and a sheet postprocessing apparatus 1 that constitute a multifunction peripheral 100 according to the embodiment of the present disclosure. As shown in FIG. 1, the multifunction peripheral 100 (image forming system) of the embodiment includes the multifunction peripheral body 101, as an image forming apparatus incorporating an image forming portion (not shown) for forming images on sheets, and the sheet postprocessing apparatus 1.

The multifunction peripheral body 101 includes an image forming portion (not shown) that forms an image on a sheet such as of paper and a body discharge portion 102 that discharges the sheet having an image formed on it by the image forming portion (i.e., the printed sheet) to the sheet postprocessing apparatus 1 or the like.

As shown in FIG. 1, by the sheet postprocessing apparatus 1, the sheet T having the image formed on it in the multifunction peripheral body 101 and discharged from the multifunction peripheral body 101 is carried into a housing 11 of the sheet postprocessing apparatus 1 through an inlet portion 60 provided in an upper part of the right side face of the sheet postprocessing apparatus 1. The sheet T so carried in is then subjected to predetermined postprocessing such as stapling and folding.

The sheet postprocessing apparatus 1 includes a sheet folding portion 2, a stapling portion 3, a punching portion 4, a main discharge tray 51, a subsidiary discharge tray 52, and a control portion 200. The sheet postprocessing apparatus 1 further includes an inlet portion 60, a first conveying passage L1, a second conveying passage L2, a third conveying passage L3, a first branch portion P1, a second branch portion P2, a third branch portion P3, a first junction portion Q1, a main discharge portion 61, a subsidiary discharge portion 62, a retraction drum 71, various switching members, and various rollers or pairs of rollers.

First, the configuration related to the conveying of the sheet T will be described. The inlet portion 60 is where the sheet T discharged from the body discharge portion 102 of the multifunction peripheral body 101 is carried in. The first conveying passage L1 conveys the sheet T carried in from the inlet portion 60 to the main discharge portion 61. The sheet T discharged from the main discharge portion 61 is discharged to the main discharge tray 51.

The second conveying passage L2 branches off the first conveying passage L1 at the first branch portion P1. The second conveying passage L2 conveys the sheet T conveyed to the first branch portion P1 to the subsidiary discharge portion 62. The sheet T discharged from the subsidiary discharge portion 62 is discharged to the subsidiary discharge tray 52.

The third conveying passage L3 branches off the first conveying passage L1 at the second branch portion P2 and extends up to the sheet folding portion 2. The second branch portion P2 is located downstream of the first branch portion P1 of the first conveying passage L1. A fourth conveying passage L4 branches off the third conveying passage L3 at the third branch portion P3, curves along the circumference of the retraction drum 71, and joins the first conveying passage L1 at the first junction portion Q1. The first junction portion Q1 is located between the first and second branch portions P1 and P2 of the first conveying passage L1.

A pair of first intermediate rollers 80 is disposed just in front of the first branch portion P1 of the first conveying passage L1. The pair of first intermediate rollers 80 feeds downstream the sheet T conveyed in front of the first branch portion P1 of the first conveying passage L1.

A first switching claw 72 is provided in the first branch portion P1 and switches the destination of the sheet T conveyed along the first conveying passage L1 between farther along the first conveying passage L1 or into the second conveying passage L2. A second switching claw 73 is provided in the second branch portion P2 and switches the destination of the sheet T conveyed along the first conveying passage L1 between farther along the first conveying passage L1 or into the third conveying passage L3.

The punching portion 4 is disposed in a region in the first conveying passage L1 between the inlet portion 60 and the first branch portion P1. The punching portion 4 performs punching on the sheet T with predetermined timing.

A pair of discharge rollers 81 is disposed in an end part of the first conveying passage L1, near the main discharge portion 61. The pair of discharge rollers 81 feeds out to the main discharge tray 51 the sheet T conveyed in the end part of the first conveying passage L1.

When the sheet T is fed out to the stapling portion 3, the pair of discharge rollers 81 move away from each other to release the nip. Then the sheet T is fed out to the stapling portion 3 by an unshown sheet feeding mechanism. The pair of discharge rollers 81 will be described in detail later.

The main discharge tray (discharge tray) 51 receives the sheet T discharged from the main discharge portion 61 by the pair of discharge rollers 81. That is, on the main discharge tray (discharge tray) 51, sheets T discharged by the pair of discharge rollers 81 are stacked. The main discharge tray 51 chiefly receives the bundle of sheets T having undergone stapling in the stapling portion 3 and then discharged from the main discharge portion 61. The main discharge tray 51 is configured to be gradually lowered from the highest position as the number of copies in the bundles of sheets T discharged increases. When the bundles of sheets T are removed from the main discharge tray 51, the main discharge tray 51 rises back to the standard position.

It is also possible to receive in the main discharge tray 51 sheets T that are discharged without being subjected to any postprocessing in the sheet postprocessing apparatus 1 or sheets T that have undergone only punching.

A pair of subsidiary discharge portion rollers 82 is disposed in an end part of the second conveying passage L2, near the subsidiary discharge portion 62. The pair of subsidiary discharge portion rollers 82 feeds out to the subsidiary discharge tray 52 the sheet T conveyed in the end part of the second conveying passage L2. The subsidiary discharge tray 52 receives the sheet T discharged from the subsidiary discharge portion 62 by the pair of subsidiary discharge portion rollers 82. The subsidiary discharge tray 52 chiefly receives sheets T that are discharged without being subjected to any postprocessing in the sheet postprocessing apparatus 1 or sheets T that have undergone only punching.

The sheet folding portion 2 is disposed in a lower part of the housing 11. The sheet folding portion 2 is disposed in a lowest part of the housing 11 of the sheet postprocessing apparatus 1. The sheet folding portion 2 is provided downstream of the third conveying passage L3 and, to it, chiefly bundles of sheets T having undergone stapling are carried in. Thus, the sheet folding portion 2 chiefly performs folding on bundles of sheets T. When a user selects folding, the sheet folding portion 2 performs folding such as double folding or triple folding on the bundle of sheets and then discharges it to a lower discharge tray 224 provided in a lower part of one side face of the housing 11 of the sheet postprocessing apparatus 1.

The stapling portion (postprocessing portion) 3 has a processing tray 31 on which sheets are stacked and performs predetermined processing on the sheets T stacked on the processing tray 31. The stapling portion (postprocessing portion) 3 performs stacking by stacking a plurality of sheets T on the processing tray 31 to form a bundle of sheets T. The stapling portion 3 also performs various kinds of stapling such as end binding in which it binds an end part of the bundle of stacked sheets T with a staple. For example, end binding includes end-middle binding in which the bundle of sheets T is bound near the middle of one end of it at two places along the longitudinal direction and end-slant binding in which the bundle of sheets T is bound slantly at 45° at one place in one corner along one end of it. The bundle of sheets T having undergone stacking or end binding is discharged from the main discharge portion 61 by the pair of discharge rollers 81.

The retraction drum 71 conveys a sheet T diverted from the first conveying passage L1 and conveyed along the third conveying passage L3 to the fourth conveying passage L4 to make it circulate via the first conveying passage L1. This permits the sheet T to be temporarily retracted. When a plurality of bundles of sheets T are stapled continuously, while one bundle of sheets T is being stapled in the stapling portion 3, one or more sheets from the subsequent bundle of sheets T are wound around the surface of the retraction drum 71 to be kept on standby. This operation of the retraction drum 71 eliminates the need to temporarily stop the discharge of sheets T from the multifunction peripheral body 101 during stapling. This leads to improved productivity.

The control portion 200 is configured with a CPU or the like and is connected to a storage portion (not shown) comprising a ROM, a RAM, and the like. Based on control programs and control data stored in the storage portion, the control portion 200 controls different blocks of the sheet postprocessing apparatus 1 (such as the sheet folding portion 2, the stapling portion 3, the punching portion 4, and the retraction drum 71).

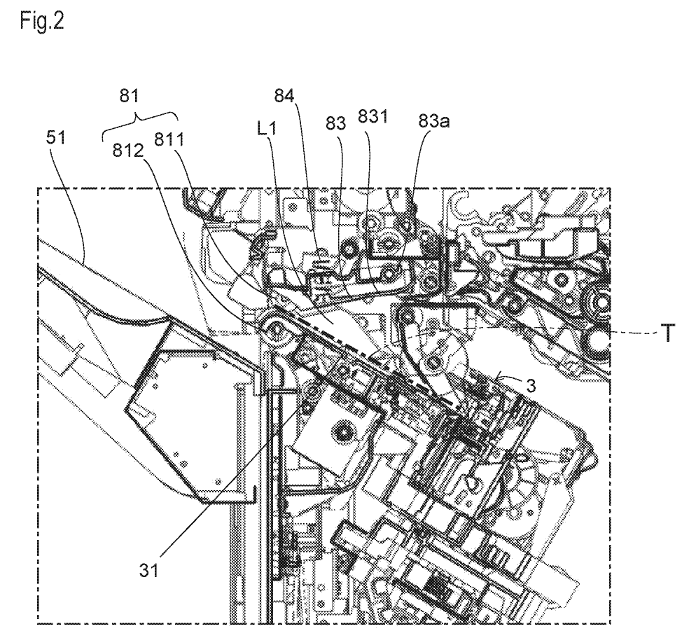

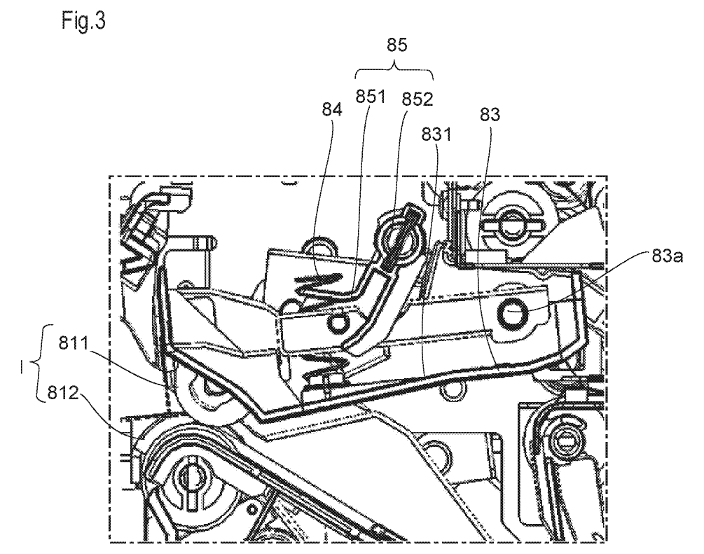

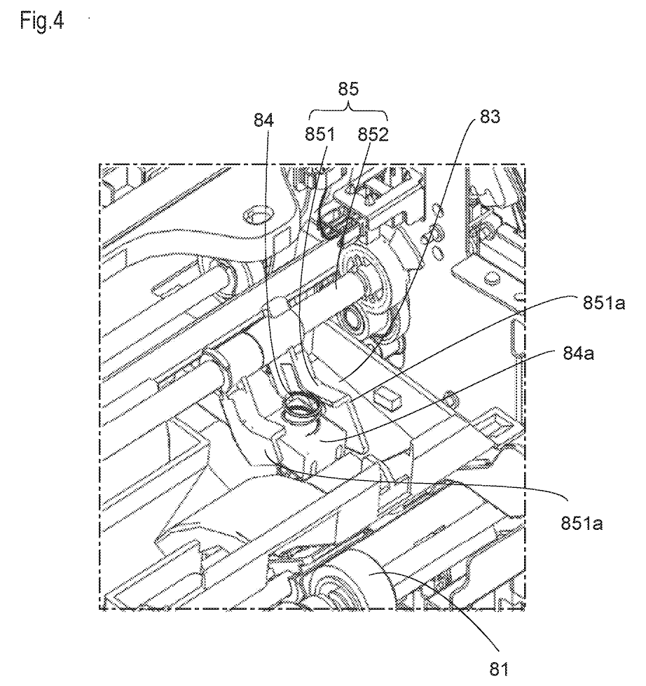

Next, with reference to FIGS. 2 and 3, the structure of the pair of discharge rollers 81 in the sheet postprocessing apparatus 1 of the embodiment will be described in detail. FIGS. 2 and 3 are side sectional views on an enlarged scale around the pair of discharge rollers 81 in the sheet postprocessing apparatus 1. In FIG. 2, a chain line indicates a bundle of sheets T. FIG. 4 is a perspective view on an enlarged scale around the pair of discharge rollers 81 in the sheet postprocessing apparatus 1.

The sheet postprocessing apparatus 1 of the embodiment further includes a holder 83, a pressing portion 85, and a control portion 200. The pair of discharge rollers 81 is composed of an upper discharge roller 811 and a lower discharge roller 812. The holder 83 holds the upper discharge roller 811 rotatably and is supported pivotably with respect to the apparatus body including the housing 11.

In the embodiment, a bottom wall 831 of the holder 83 forms part of an upper wall of the first conveying passage L1. The holder 83, in a downstream end part of it in the sheet discharge direction, holds the upper discharge roller 811 rotatably. The holder 83 pivots about a pivot shaft 83a disposed in an upstream end part of it in the sheet discharge direction.

The holder 83 has a coil spring (elastic member) 84 connected to the upper surface of the bottom wall 831. The coil spring 84 is disposed at each of a plurality of places along the axial direction of the upper discharge roller 811. In the embodiment, the coil spring 84 has its lower end fixed to the bottom wall 831 and extends upward. The coil spring 84 has a pressing segment 84a connected to an upper end part of it. The pressing segment 84a protrudes from the coil spring 84 to each side along the axial direction of the upper discharge roller 811, and the top face of the pressing segment 84a makes contact with a pivotable segment 851 of the pressing portion 85.

The pressing portion 85 has a pivotable segment 851 supported so as to be pivotable about a shaft 852 and a motor (not shown) that rotates the shaft 852. In the embodiment, the shaft 852 extends parallel to the rotation axis of the upper discharge roller 811, and the pivotable segment 851 is disposed one at each of a plurality of places corresponding to the coil spring 84. The pivotable segment 851 has a pair of side wall portions 851a that respectively face the opposite side faces of the pressing segment 84a along the axial direction. Upper end parts of the side wall portions 851a are bent along the axial direction so as to approach each other.

The motor (not shown) is connected to the control portion 200 and, as the number of pulses is changed, changes the rotation position of the shaft 852. As the shaft 852 rotates, the pivotable segment 851 pivots and compresses the coil spring 84. In this way, the coil spring 84 can be compressed with a simple structure, and this helps suppress an increase in the manufacturing cost of the sheet postprocessing apparatus 1.

More specifically, rotating the shaft 852 and thereby pivoting the pivotable segment 851 downward results in the pivotable segment 851 pressing the pressing segment 84a downward and compressing the coil spring 84. Meanwhile, based on the number of pulses for the motor, the control portion 200 changes the degree of compression of the coil spring (elastic member) 84. In this way, the control portion 200 can accurately control the degree of compression of the coil spring 84.

As the pivotable segment 851 is pivoted downward and the degree of compression of the coil spring (elastic member) 84 increases, the pressing force that acts on the holder 83 under the urging force of the coil spring 84 increases. Thus, the roller pressure from the upper discharge roller 811 to the lower discharge roller 812 increases.

Reversely, as the pivotable segment 851 is pivoted upward and the degree of compression of the coil spring (elastic member) 84 reduces, the pressing force that acts on the holder 83 under the urging force of the coil spring 84 reduces. Thus, the roller pressure from the upper discharge roller 811 to the lower discharge roller 812 reduces.

When the shaft 852 is rotated to move the pivotable segment 851 apart from the pressing segment 84a, the degree of compression of the coil spring 84 is zero. In this state, the roller pressure from the upper discharge roller 811 to the lower discharge roller 812 just equals the self weight of the holder 83 including the upper discharge roller 811.

In the embodiment, the control portion 200 can execute a postprocessing mode in which it performs postprocessing while keeping the degree of compression of the coil spring (elastic member) 84 constant regardless of the number of sheets T stacked on the processing tray 31. In the postprocessing mode, keeping the degree of compression of the coil spring (elastic member) 84 constant permits the bundle of sheets T to be discharged from the pair of discharge rollers 81 with a constant roller pressure regardless of the number of sheets in the postprocessed bundle of sheets T. For example, the degree of compression of the coil spring (elastic member) 84 is equal between when a bundle of 20 sheets T stacked on the processing tray 31 is discharged from the pair of pair of discharge rollers 81 and when a bundle of 50 sheets T is discharged from the pair of pair of discharge rollers 81. This eliminates the need to change the roller pressure setting and thus helps shorten the time that elapses, when bundles of sheets T with varying numbers of sheets are postprocessed continuously, before they are discharged from the pair of discharge rollers 81. It is thus possible to improve the speed of postprocessing on sheets T.

The coil spring (elastic member) 84 is compressed to press the upper discharge roller 811 against the lower discharge roller 812. Thus, the coil spring 84 with its elastic force absorbs the bouncing of the upper discharge roller 811 when the bundle of sheets T enters the pair of discharge rollers 81. It is thus possible to suppress a lag in the timing of discharge of the bundle of sheets T and prevent a jam.

The degree of compression of the coil spring (elastic member) 84 in the postprocessing mode can be changed based on the thickness or paper quality of sheets T. Then, the degree of compression of the coil spring (elastic member) 84 can be set to suit the thickness or paper quality of sheets T and this helps further suppress a lag in the timing of discharge of the bundle of sheets T.

The embodiment described above is not meant to limit the scope of the present disclosure, which can thus be implemented with any modifications made without departure from the scope of the appended claims. For example, of the various features of the embodiment described above, any can be omitted or any can be combined with any other in manners different from what is disclosed above. For example, while in the embodiment a coil spring 84 is used as an elastic member, any other elastic member can be used.

The present disclosure finds applications in image forming apparatuses provided with a sheet postprocessing apparatus.

What is claimed is:

1. A sheet postprocessing apparatus comprising:
a postprocessing portion that performs predetermined postprocessing on a sheet staked on a processing tray;
a pair of discharge rollers disposed downstream of the processing tray in a sheet discharge direction, the pair of discharge rollers discharging the sheet along a conveying direction while holding the sheet; and
a discharge tray on which the sheet discharged by the pair of discharge rollers is stacked,
wherein
the pair of discharge rollers is composed of an upper discharge roller and a lower discharge roller that can be brought into and out of contact with each other, and
the sheet postprocessing apparatus further includes:
a holder that supports the upper discharge roller rotatably and that is supported so as to be pivotable with respect to an apparatus body;
a pressing portion that presses the upper discharge roller against the lower discharge roller by compressing an elastic member connected to the holder; and
a control portion that can change a degree of compression of the elastic member by controlling operation of the pressing portion.

2. The sheet postprocessing apparatus according to claim 1, wherein
the pressing portion incudes:
a pivotable segment supported so as to be pivotable about a shaft; and
a motor that rotates the shaft, and
the elastic member is compressed by the pivotable segment pivoting and pressing the elastic member.

3. The sheet postprocessing apparatus according to claim 2, wherein
the control portion changes the degree of compression of the elastic member based on a number of pulses for the motor.

4. The sheet postprocessing apparatus according to claim 1, wherein
the control portion can execute a postprocessing mode in which postprocessing is performed with the degree of compression of the elastic member kept constant regardless of a number of sheets stacked on the processing tray.

5. An image forming system comprising:
the sheet postprocessing apparatus according to claim 1; and
an image forming apparatus that forms an image on the sheet and that then conveys the sheet to the postprocessing portion.
